(19) United States
(12) Patent Application Publication
(10) Pub. No.: US 2008/0241696 A1
(43) Pub. Date: Oct. 2, 2008

(54) ELECTRODE AND ELECTROCHEMICAL DEVICE

(75) Inventors: Kiyonori HINOKI, Tokyo (JP); Yousuke MIYAKI, Tokyo (JP); Kazuo KATAI, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/053,203

(22) Filed: Mar. 21, 2008

(30) Foreign Application Priority Data
Mar. 30, 2007 (JP) 2007-092817

(51) Int. Cl. H01M 4/36

(52) U.S. Cl. 429/231.8; 429/209

(57) ABSTRACT

An electrode is provided as one capable of adequately maintaining voids in a surface layer and an electrochemical device is provided as one using the electrode. The electrode has a current collector, and an active material-containing layer provided on the current collector and containing active material particles, the number of peaks in a particle size distribution of the active material particles in a lower part on the current collector side in the active material-containing layer is larger than the number of peaks in a particle size distribution of the active material particles in a surface part on the opposite side to the current collector in the active material-containing layer, and a thickness of the lower part is not less than 50% nor more than 90% of a total thickness of the surface part and the lower part.

### BACKGROUND OF THE INVENTION

1. Field of the Invention

The present invention relates to an electrode and an electrochemical device.

2. Related Background Art

A known electrode in an electrochemical device such as a lithium secondary battery has a structure in which an active material-containing layer is laid on a current collector. The electrode of this structure is made by applying a paste containing active material particles, a binder, a conductive aid, and a solvent, onto the current collector, drying the paste to evaporate the solvent, and then pressing a coating film. A purpose of this press is to enhance the volume energy density of the electrode (cf. Japanese Patent Application Laid-open No. 9-63588).

### SUMMARY OF THE INVENTION

Incidentally, there are recent needs not only for achievement of a sufficient capacity, but also for suppressing generation of heat during overcharging.

The present invention has been accomplished in view of the above problem and an object of the present invention is to provide an electrode capable of suppressing the generation of heat during overcharging and achieving a sufficient capacity, and an electrochemical device using the same.

The inventors conducted elaborate research and found that, for increasing the capacity, it was preferable to increase the filling factor in the active material-containing layer with the use of active material particles having a plurality of peaks in a particle size distribution. However, we also found the following fact: as the filling factor of the active material particles increases in the surface part in this manner, voids in the surface part become more likely to be crushed by the press process, so as to degrade the penetrant diffusion capability of an electrolyte and the electrolyte tends to remain in the surface part to readily cause deposition of dendrites and generation of heat.

An electrode according to the present invention comprises a current collector, and an active material-containing layer provided on the current collector and containing active material particles. A number of peaks in a particle size distribution of the active material particles in a lower part on the current collector side in the active material-containing layer is larger than a number of peaks in a particle size distribution of the active material particles in a surface part on the opposite side to the current collector in the active material-containing layer, and a thickness of the lower part is not less than 50% nor more than 90% of a total thickness of the surface part and the lower part.

According to the present invention, the filling factor of the active material particles in the lower part becomes relatively higher than that in the surface part whereby the capacity is increased in the lower part. Since the filling factor of the active material particles in the surface part is lower than that in the lower part, voids are maintained in the surface part, which guarantees the penetrant diffusion capability of the electrolyte and thus suppresses deposition of dendrites of electrolyte ions in the surface part. Particularly, since the ratio of the thicknesses of these surface part and lower part is set in the extremely appropriate range, the capacity and safety during overcharging both are satisfied together to a high degree.

Specifically, the thickness of the lower part is preferably not less than 40 μm nor more than 160 μm. If the thickness of the lower part is smaller than 40 μm, the volume energy density of the electrode tends to decrease. If the thickness of the lower part is larger than 160 μm, the pressure of the press on the upper part tends to reach the lower part and voids tend to be crushed easier near the upper region of the lower part. The cause of this phenomenon is not fully clear yet, but it is considered that the thickness of the upper part decreases relative to the lower part and it leads influence of the press to the lower part.

Preferably, in the lower part, where a particle size of one peak in the particle size distribution of the active material particles is defined as 1, a particle size of another peak is not less than 0.125 nor more than 0.5. This satisfactorily increases the filling factor of the active material in terms of the function of the battery. If the particle size of the other peak is smaller than 0.125, the filling factor tends to become so high as to impede penetration of the electrolyte. If the particle size of the other peak is larger than 0.5, the filling factor of the active material tends to be insufficient in terms of the function of the battery.

A battery according to the present invention is an electrochemical device comprising the above-described electrode.

The present invention provides the electrode capable of suppressing the generation of heat during overcharging and achieving a sufficient capacity and the electrochemical device using the electrode.

### BRIEF DESCRIPTION OF THE DRAWINGS

FIG. 1 is a schematic sectional view of an electrode according to an embodiment of the present invention.

FIG. 2 is a drawing showing particle size distributions of active material particles.

FIG. 3 is a schematic sectional view of a lithium-ion secondary battery according to an embodiment of the present invention.

FIG. 4 is a table showing the conditions and results in Examples 1-10.

FIG. 5 is a table showing the conditions and results in Examples 11-16 and Comparative Examples 1-4.

### DESCRIPTION OF THE PREFERRED EMBODIMENTS

The preferred embodiments of the present invention will be described below in detail with reference to the accompanying drawings Identical or equivalent elements will be denoted by the same reference symbols in the description of the drawings, without redundant description. It is also noted that the dimensional ratios in the drawings do not always agree with actual dimensional ratios.

(Electrode)

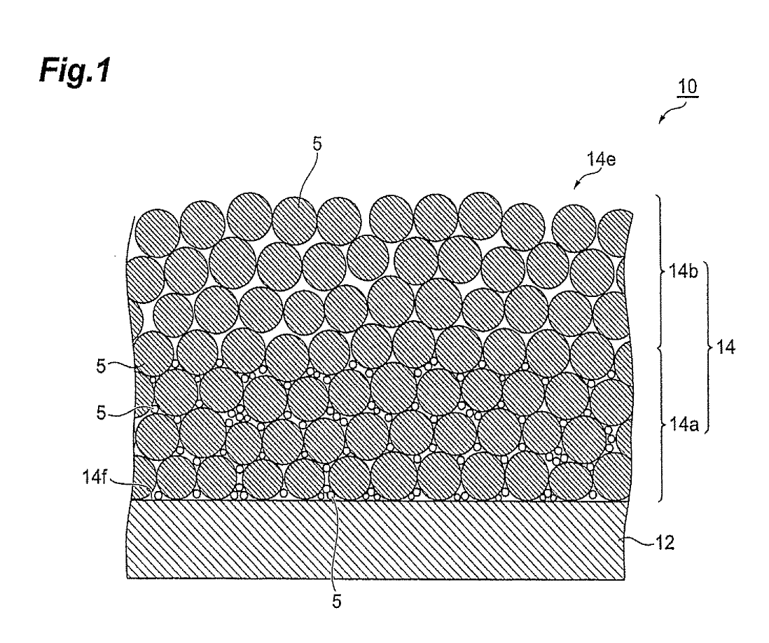

First, an electrode according to an embodiment of the present invention will be described with reference to FIG. 1. The electrode 10 is one in which an active material-containing layer 14 is laid on a current collector 12.

The current collector 12 can be, for example, an aluminum foil (suitable particularly for a positive electrode), a copper foil (suitable particularly for a negative electrode), or a nickel foil.

The active material-containing layer 14 is a layer containing active material particles 5, a binder (not shown), and a conductive aid (not shown) which is added according to need. The conductive aid stated herein is a material added in order to enhance the electron conductivity of the active material-containing layer 14, is generally a carbon material of small particle sizes, and is distinguished from the active material particles 5 in the present invention because of the difference of structure. The conductive aid can be acetylene black or carbon black. These have the appearance like a string of beads of carbon agglomerate called an aggregate or structure, and have the specific surface area as large as 30 m²/g or more. It is often the case that there is no clear crystal peak recognized by X-ray diffraction. This morphological feature is different from that of the active material particles 5 in the present invention, by which they can be discriminated from each other The conductive aid has high electron conductivity but has no substantial charge-discharge performance, and therefore the conductive aid cannot be regarded as an active material. In the present invention, the conductive aid can be used in order to enhance the electron conductivity, but it is difficult to use it as active material particles 5.

Examples of anode active material particles include carbon particles such as particles of graphite, non-graphitizing carbon, graphitizing carbon, and low temperature-calcined carbon capable of occluding and releasing (intercalating and deintercalating, or doping and dedoping with) lithium ions, composite material particles of carbon and metal, particles of metals such as Al, Si, and Sn capable of combining with lithium, and particles containing lithium titanate (Li₄Ti₅O₁₂) or the like. Particularly, the carbon particles of graphite, graphitizing carbon, etc. are particularly suitable for the present invention because they are so soft as to be extremely easily crushed in an after-described surface part 14b during press.

Examples of cathode active material particles include lithium oxides containing at least one metal selected from the group consisting of Co, Ni, and Mn, such as LiMO₂ (where M is Co, Ni, or Mn), LiCoₓNi₁₋ₓO₂, LiMn₂O₄, LiCoₓNi_{y}Mn_{1-x-y}O₂ (where each of x and y is more than 0 and less than 1), and, particularly, LiCoₓNi_{y}Mn_{1-x-y}O₂ is more preferably applicable.

There are no particular restrictions on the binder as long as it can bind the aforementioned active material particles and conductive aid to the current collector. The binder can be one of the well-known binders. The binder can be, for example, one selected from fluorocarbon polymers such as polyvinylidene fluoride (PVDF) and polytetrafluoroethylene (PTFE), mixtures of styrene-butadiene rubber (SBR) and a water-soluble polymer (carboxymethyl cellulose, polyvinyl alcohol, sodium polyacrylate, dextrin, gluten, or the like), and so on.

The conductive aid can be, for example, one selected from carbon blacks, carbon materials, fine powders of metals such as copper, nickel, stainless steel, and iron, mixtures of the carbon materials and metal fine powders, and electrically conductive oxides such as ITO.

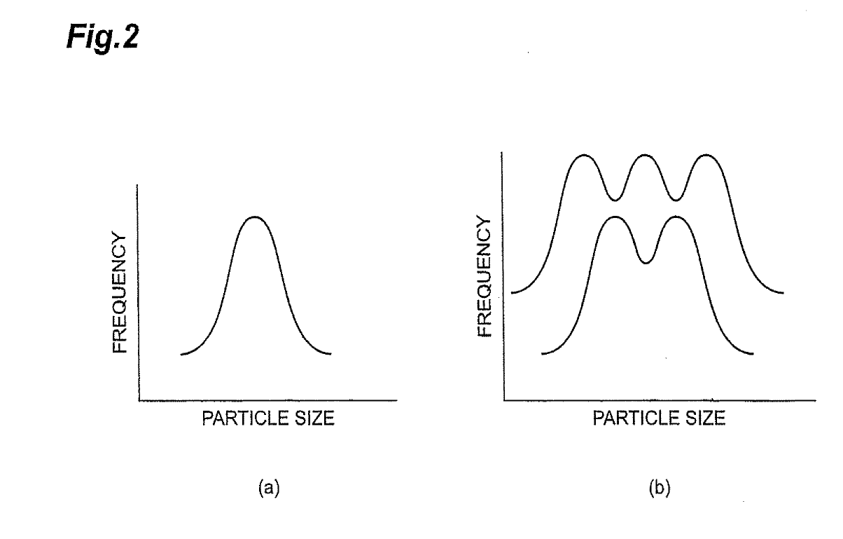

In the present embodiment, the active material-containing layer 14 has a lower part 14a including a surface 14f on the near side to the current collector 12, and a surface part 14b including a surface 14e on the opposite side to the current collector 12. The number of peaks in a particle size distribution of active material particles 5 in the lower part 14a is larger than the number of peaks in a particle size distribution of active material particles 5 in the surface part 14b. Specifically, preferred particle size distributions are, for example, as follows: the number of peaks in the particle size distribution of active material particles 5 in the surface part 14b is I as shown in (a) of FIG. 2; the number of peaks in the particle size distribution of active material particles 5 in the lower part 14a is 2 or 3 or more as shown in (b) of FIG. 2.

The surface part 14b and the lower part 14a may or may not have an identical peak in their particle size distributions. The lower part 14a preferably has the following particle size distribution with heights of peaks: where a height of a peak being a maximum height is defined as 1, a height of another peak is not less than 0.6 and, preferably, not less than 0.8.

The thickness of the lower part 14a is not less than 50% nor more than 90% of the total thickness of the surface part 14b and the lower part 14a. If the thickness of the lower part 14a is less than 50%, it is hard to obtain a sufficient capacity. If the thickness of the lower part 14a is more than 90% to the contrary, it results in weakening the effect of suppressing the generation of heat during overcharging. Preferably, the thickness of the lower part 14a is not less than 50% nor more than 80% of the total thickness of the surface part 14b and lower part 14a. When this relationship is met, there is a tendency of being capable of enhancing the filling factor of the lower part 14a, while preventing the press on the surface part 14b from affecting the lower part 14a.

A specific thickness of the lower part 14a can be optionally selected according to use and materials of the electrode, but it can be set, for example, in the range of 40 to 160 μm.

In the lower part 14a, where a particle size of one peak in the particle size distribution of active material particles 5 is defined as 1, a particle size of another peak is preferably not less than 0.125 nor more than 0.5. This can increase the filling factor in the lower part 14a.

The relationship between thickness and particle size distribution of the surface part 14b and the lower part 14a may be determined so that a particle size of a peak being a maximum particle size among peaks in the particle size distribution can fall within the thickness range of each part. For example, let us suppose a case where the surface part 14b is formed in the thickness of 30 μm. In this case, even if the particle size distribution ranges from 8 μm to 40 μm, the surface part 14b can be formed therewith if the particle size of the peak being the maximum particle size is 25 μm. However, particles in sizes over the thickness could project through the outermost surface, be buried in the lower part 14a, or be crushed by the press. If such phenomena become unignorable from the viewpoint of the penetrant capability of the electrolyte or the like, the particles are preferably used by preliminarily removing coarse particles in particle sizes over the thickness of the surface part 14b and the lower part 14a.

It is preferable to use the same active material particles for the lower part 14a and the surface part 14b, but the present invention can also be carried out with the use of different active material particles.

It is also possible to adopt a multilayer structure for each of the lower part 14a and the surface part 14b, itself.

(Production Method of Electrode)

This electrode can be produced as follows. The active material particles 5, the binder, and a necessary amount of the conductive aid are added in a solvent such as N-methyl-2-pyrrolidone or N,N-dimethylformamide to obtain a slurry, and the slurry is applied onto the surface of the current collector 12, and is then dried. This step is repeated twice. In this process, the number of peaks in the particle size distribution of active material particles 5 in the slurry applied for formation of the lower part 14a is set larger than the number of peaks in the particle size distribution of active material particles 5 in the slurry applied thereafter for formation of the surface part 14b. Specifically, for example, the active material particles 5 in the slurry applied for formation of the lower part 14a may be a mixture of two types of active material particles each of which has a particle size distribution with a single peak at a particle size different from that of the other. Preferably, after formation of each of the layers, the electrode is pressed with a press machine of roll press or the like. The linear pressure during the press can be, for example, 981 to 19613 N/cm (100-2000 kgf/cm). The linear pressure in the press of the lower part is preferably lower than that in the press of the surface part. For example, the linear pressure is set to about 500 kgf/cm during single press of the lower part 14a and the linear pressure is set to about 1000 kgf/cm during the press of the lower part 14a and the surface part 14b after formation of the surface part 14b, which can prevent the crush in the lower part 14a. The active material particles in the lower part 14a may be graphite with mechanical strength enhanced by a surface treatment with amorphous carbon or the like, if needed, to prevent deformation. This graphite may also be used as active material particles in the surface part 14b. Alternatively, it is also possible to optionally select a material with elasticity as the binder material of the lower part 14a, so as to prevent the crush. The binder material with elasticity can be, for example, an elastomer.

(Action and Effect)

In the present embodiment, the filling factor of active material particles 5 in the lower part 14a is relatively higher than that in the surface part 14b, so as to increase the capacity in the lower part 14a. Since the filling factor of active material particles 5 in the surface part 14b is lower than that in the lower part 14a, voids are maintained in the surface part 14b to guarantee the penetrant diffusion capability of the electrolyte and thus suppress the deposition of dendrites of electrolyte ions in the surface part 14b. Particularly, since the ratio of the thicknesses of these surface part 14b and lower part 14a is set in the extremely appropriate range, the capacity and the safety during overcharging both can be achieved together to a high degree.

(Electrochemical Device)

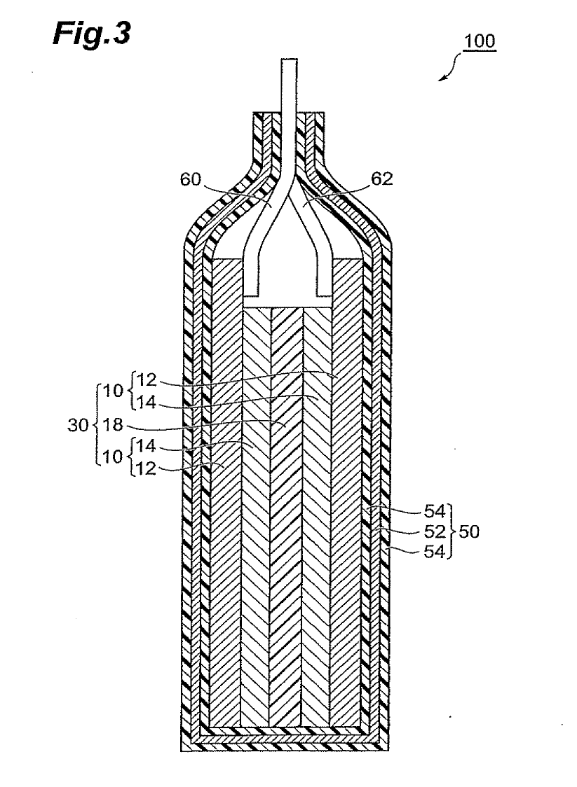

Next, an example of an electrochemical device according to the present invention will be described. FIG. 3 shows an example of a lithium-ion secondary battery.

This lithium-ion secondary battery 100 is composed mainly of a laminate 30, a case 50 housing the laminate 30 in a hermetically closed state, and a pair of leads 60, 62 connected to the laminate 30.

The laminate 30 has a structure in which a pair of electrodes 10, 10 are opposed to each other with a separator 18 in between. Two active material-containing layers 14 are located in contact on both sides of the separator 18. The leads 60, 62 are connected to respective ends of current collectors 12 and the ends of the leads 60, 62 extend outward from the case 50. One electrode 10 serves as a positive electrode and the other electrode 10 as a negative electrode.

An electrolyte solution is contained inside each of the active material-containing layers 14 and the separator 18. There are no particular restrictions on the electrolyte solution, and in the present embodiment, the electrolyte solution can be, for example, an electrolyte solution (an aqueous electrolyte solution, or an electrolyte solution using an organic solvent) containing a lithium salt. However, the aqueous electrolyte solution has a low electrochemical decomposition voltage and thus the withstanding voltage in charging is limited to a low level; therefore, it is preferable to adopt an electrolyte solution using an organic solvent (i.e., a nonaqueous electrolyte solution). The electrolyte solution preferably used herein is a nonaqueous electrolyte solution in which a lithium salt is dissolved in a nonaqueous solvent (an organic solvent). The lithium salt used herein can be, for example, one of salts such as LiPF₆, LiClO₄, LiBF₄, LiAsF₆, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO), LiN(CF₃CF₂CO)₂, and LiBOB. These salts may be used singly or in combination of two or more.

Examples of organic solvents preferably applicable herein include propylene carbonate, ethylene carbonate, and diethylcarbonate. These may be used singly or as a mixture of two or more at any ratio.

In the present embodiment, the electrolyte solution does not always have to be the liquid electrolyte but may also be a gel electrolyte obtained by adding a gelatinizing agent in the solution. The electrolyte solution may also be replaced by a solid electrolyte (a solid polymer electrolyte or an electrolyte consisting of an ion-conductive inorganic material).

The separator 18 can also be any electrically insulating porous material and can be, for example, one of monolayer and multilayer bodies of film of polyethylene, polypropylene, or polyolefin, stretched films of mixtures of the foregoing polymers, or nonwoven fabric of fiber consisting of at least one constituent material selected from the group consisting of cellulose, polyester, and polypropylene.

The case 50 hermetically houses the laminate 30 and the electrolyte solution inside. There are no particular restrictions on the case 50 as long as it can suppress leakage of the electrolyte solution to the outside, and intrusion or the like of water and others from the outside to the interior of the electrochemical device 100. For example, the case 50 can be a metal laminate film obtained by coating a metal foil 52 with polymer films 54 on both sides, as shown in FIG. 3. The metal foil 52 can be, for example, an aluminum foil and the polymer films 54 can be films of polypropylene or the like. For example, a material of the outside polymer film 54 is preferably a polymer with a high melting point, e.g., polyethylene terephthalate (PET) or polyamide, and a material of the inside polymer film 54 is preferably polyethylene, polypropylene, or the like.

The leads 60, 62 are made of an electrically conductive material such as aluminum.

It is also possible to adopt the structure of FIG. 1 for only one of the electrodes. For example, in the case of a lithium-ion secondary battery, only the negative electrode may be formed in the structure of FIG. 1, with sufficient effect.

The present invention is not limited to the above embodiments but can be modified in various ways. For example, the electrode according to the present invention is not applicable only to the lithium-ion secondary batteries, but is also applicable, for example, to electrodes of electrochemical capacitors. Particularly, the electrode of the present invention is especially suitable for those using a carbon material as an active material.

In the examples below, peaks in particle size distributions are volume-based data measured by a Microtrac particle side analyzer (HRA(X100) available from NIKKISO CO., LTD.).

### EXAMPLE 1

Graphite particles (peak particle size: 5 μm, particle size range: 1-15 μm, 50 parts by weight) were preliminarily mixed with graphite particles (peak particle size: 20 μm, particle size range: 7-40 μm, 50 parts by weight) to obtain mixed active material particles. Next, the mixed active material particles (90 parts by weight), PVDF (8 parts by weight) as a binder, and acetylene black (2 parts by weight) as a conductive aid were mixed and dispersed in N-methyl-2-pyrrolidone with a Gaulin homogenizer to prepare a slurry, and this slurry was applied onto a copper foil (thickness: 20 μm) as an anode collector, and then dried. The resultant was roll-pressed under the linear pressure of 1961 N/cm (200 kgf) to form the lower part 92 μm thick.

Thereafter, a graphite powder (peak particle size: 20 μm, particle size range: 7-40 μm, 90 parts by weight) as active material particles, PVDF (8 parts by weight) as a binder, and acetylene black (2 parts by weight) as a conductive aid were mixed and dispersed in N-methyl-2-pyrrolidone to obtain a slurry, the slurry was applied onto the lower part and dried, and the resultant was roll-pressed under the linear pressure of 1471 N/cm (150 kgf/cm) to form the surface part 28 μm thick. However, the graphite powder was used after coarse particles over the particle size of 28 μm were separated and removed therefrom.

### EXAMPLES 2-5

Examples 2-5 were the same as Example 1 except for the following conditions: in Example 2 the thickness of the lower part was 95 μm and the thickness of the surface part 25 μm; in Example 3 the thickness of the lower part was 123 μm and the thickness of the surface part 37 μm; in Example 4 the thickness of the lower part was 87 μm and the thickness of the surface part 33 μm; in Example 5 the thickness of the lower part was 60 μm and the thickness of the surface part 60 μm. In all the cases, however, the graphite powder was used after coarse particles over the thickness were separated and removed therefrom.

### EXAMPLE 6

Example 6 was the same as Example 1 except that the mixed active material particles for the lower part used were 90 parts by weight of a mixture of graphite particles (peak particle size: 5 μm, particle size range: 1-15 μm, 25 parts by weight) and graphite particles (peak particle size: 20 μm, particle size range: 7-40 μm, 75 parts by weight) preliminarily mixed. However, the graphite powder was used after coarse particles in sizes over the thickness were separated and removed therefrom.

### EXAMPLE 7

Example 7 was the same as Example 1 except that the mixed active material particles for the lower part used were 90 parts by weight of a mixture of graphite particles (peak particle size: 5 μm, particle size range: 1-15 μm, 75 parts by weight) and graphite particles (peak particle size: 20 μm, particle size range: 7-40 μm, 25 parts by weight) preliminarily mixed. However, the graphite powder was used after coarse particles in sizes over the thickness were separated and removed therefrom.

### EXAMPLE 8

Example 8 was the same as Example 1 except that graphite particles (peak particle size: 30 μm, particle size range: 10-60 μm, 90 parts by weight) were used as the active material particles for the surface part, the thickness of the lower part was 122 μm, and the thickness of the surface part 38 μm. However, the graphite powder was used after coarse particles in sizes over the thickness were separated and removed therefrom.

### EXAMPLE 9

Example 9 was the same as Example 1 except that graphite particles (peak particle size: 25 μm, particle size range: 8-50 m, 90 parts by weight) were used as the active material particles for the surface part, the thickness of the lower part was 122 μm, and the thickness of the surface part 38 μm. However, the graphite powder was used after coarse particles in sizes over the thickness were separated and removed therefrom.

### Example 10

Example 10 was the same as Example 1 except that graphite particles (peak particle size: 15 μm, particle size range: 3-37 μm, 90 parts by weight) were used as the active material particles for the surface part, the thickness of the lower part was 95 μm, and the thickness of the surface part 25 μm. However, the graphite powder was used after coarse particles in sizes over the thickness were separated and removed therefrom.

### EXAMPLE 11

Example 11 was the same as Example 1 except that graphite particles (peak particle size: 25 μm, particle size range: 8-50 μm, 90 parts by weight) were used as the active material particles for the surface part, the thickness of the lower part was 121 μm, and the thickness of the surface part 39 μm. However, the graphite powder was used after coarse particles in sizes over the thickness were separated and removed therefrom.

### EXAMPLE 12

Example 12 was the same as Example 1 except that graphite particles (peak particle size: 10 μm, particle size range: 2-25 μm, 90 parts by weight) were used as the active material particles for the surface part, the thickness of the lower part was 121 μm, and the thickness of the surface part 39 μm. However, the graphite powder was used after coarse particles in sizes over the thickness were separated and removed therefrom.

### EXAMPLE 13

Example 13 was the same as Example 1 except that the mixed active material particles for the lower part used were a mixture of graphite particles (peak particle size: 2.5 μm, particle size range: 0.5-7.5 μm, 50 parts by weight) and graphite particles (peak particle size: 20 μm, particle size range: 7-40 μm, 50 parts by weight) preliminarily mixed, the thickness of the lower part was 121 μm, and the thickness of the surface part 39 μm. However, the graphite powder was used after coarse particles in sizes over the thickness were separated and removed therefrom.

### EXAMPLE 14

Example 14 was the same as Example 1 except that the mixed active material particles for the lower part used were a mixture of graphite particles (peak particle size: 10 μm, particle size range: 2-25 μm, 50 parts by weight) and graphite particles (peak particle size: 20 μm, particle size range: 7-40 μm, 50 parts by weight) preliminarily mixed, the thickness of the lower part was 121 μm, and the thickness of the surface part 39 μm. However, the graphite powder was used after coarse particles in sizes over the thickness were separated and removed therefrom.

### EXAMPLE 15

The lower part was formed by sequentially depositing two separate types of upper and lower layers. The lower part on the current collector side was made in the thickness of 52 μm from 90 parts by weight of mixed active material particles obtained by preliminarily mixing graphite particles (peak particle size: 5 μm, particle size range: 1-15 μm, 50 parts by weight) and graphite particles (peak particle size: 20 μm, particle size range: 7-40 μm, 50 parts by weight), and the lower part on the surface part side was made in the thickness of 40 μm from 100 parts by weight of mixed active material particles obtained by preliminarily mixing graphite particles (peak particle size: 10 μm, particle size range: 2-25 μm, 50 parts by weight) and graphite particles (peak particle size: 20 μm, particle size range: 7-40 μm, 50 parts by weight). Example 15 was the same as Example 1 except for the foregoing conditions. However, the graphite powder was used after coarse particles in sizes over the thickness were separated and removed therefrom.

### EXAMPLE 16

The lower part was made by sequentially depositing three separate types of upper, middle, and lower layers. The lower part on the current collector side was made in the thickness of 44 μm from 90 parts by weight of mixed active material particles obtained by preliminarily mixing graphite particles (peak particle size: 5 μm, particle size range: 1-15 μm, 50 parts by weight) and graphite particles (peak particle size: 20 μm, particle size range: 7-40 μm, 50 parts by weight), the middle lower part was made in the thickness of 23 μm from 90 parts by weight of mixed active material particles obtained by preliminarily mixing graphite particles (peak particle size: 7 μm, particle size range. 1.4-21 μm, 50 parts by weight) and graphite particles (peak particle size: 20 μm, particle size range: 7-40 μm, 50 parts by weight), and the lower part on the surface part side was made in the thickness of 25 μm from 90 parts by weight of mixed active material particles obtained by preliminarily mixing graphite particles (peak particle size: 10 μm, particle size range: 2-25 μm, 50 parts by weight) and graphite particles (peak particle size: 20 μm, particle size range: 7-40 μm, 50 parts by weight) preliminarily mixed. Example 16 was the same as Example 1 except for the foregoing conditions. However, the graphite powder was used after coarse particles in sizes over the thickness were separated and removed therefrom.

### COMPARATIVE EXAMPLE 1

Comparative Example 1 was the same as Example 1 except that the surface part was not formed and only the lower part was formed in the thickness of 120 μm.

### COMPARATIVE EXAMPLE 2

Comparative Example 2 was the same as Example 1 except that the lower part was not formed and only the surface part was formed in the thickness of 120 μm.

### COMPARATIVE EXAMPLE 3

Comparative Example 3 was the same as Example 1 except that the thickness of the lower part was 50 μm and the thickness of the surface part 70 μm.

### COMPARATIVE EXAMPLE 4

Comparative Example 4 was the same as Example 1 except that the active materials used in the surface part and in the lower part were interchanged.

[Measurement of Characteristics of Electrode]

Lithium-ion secondary batteries were fabricated as follows: a positive electrode was made by forming an active material layer containing active material particles (LiCoO₂, 89 parts by weight), a binder (PVdF, 5 parts by weight), and a conductive aid (acetylene black and graphite, 3 parts by weight of each), on a current collector of aluminum, polyethylene was used as a separator, 1M LiPF₆/PC was used as an electrolyte, and each of the above-described electrodes was used as a negative electrode.

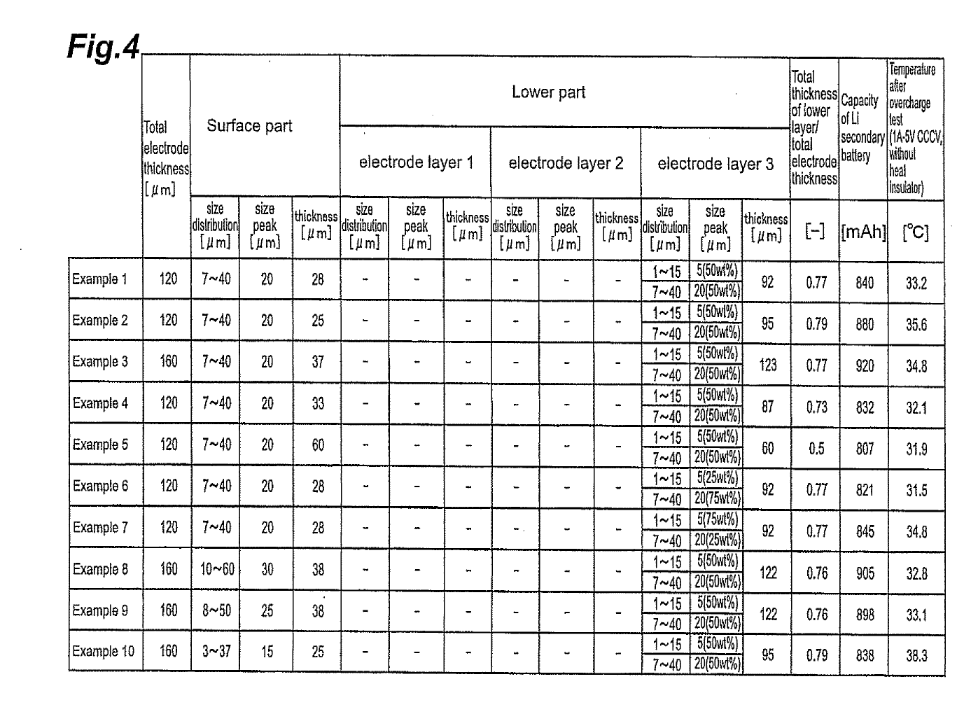

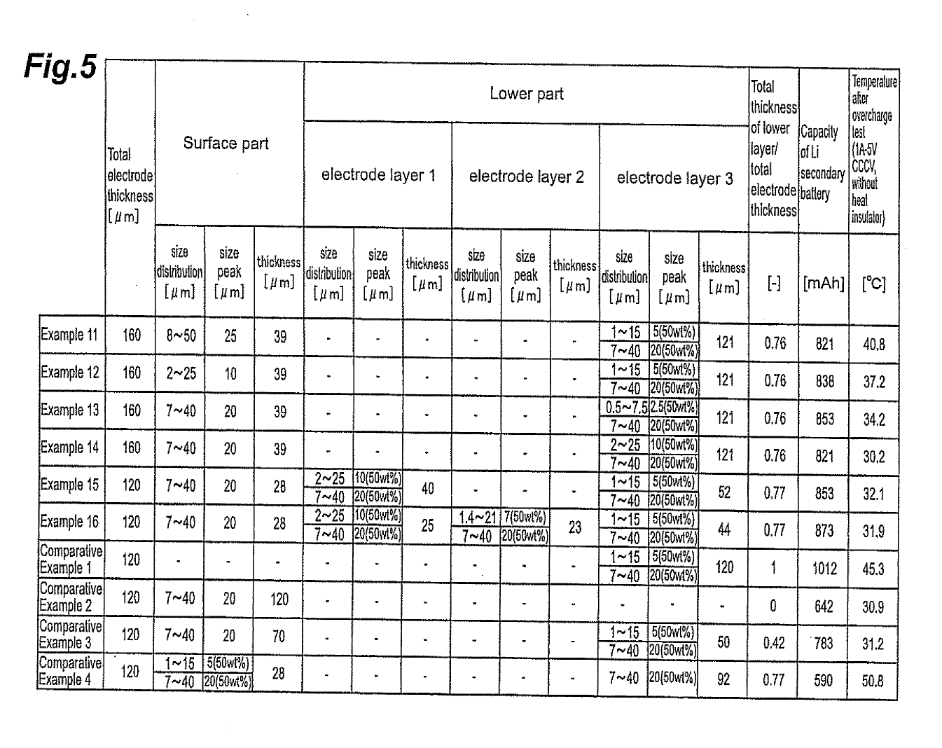

An overcharging test was conducted as follows: each battery was charged by constant-current charge at 1 A, the battery was then charged up to 5 V, the battery was charged thereafter by constant-voltage charge, and its final charge capacity and maximum arrival temperature were obtained. The results are presented in FIGS. 4 and 5.

The comparative examples failed to achieve a satisfactory capacity and suppression of heat generation during overcharging together, whereas the examples succeeded in achieving the both.

What is claimed is:

1. An electrode comprising:
a current collector; and
an active material-containing layer provided on the current collector and containing active material particles;
wherein a number of peaks in a particle size distribution of the active material particles in a lower part on the current collector side in the active material-containing layer is larger than a number of peaks in a particle size distribution of the active material particles in a surface part on the opposite side to the current collector in the active material-containing layer, and
wherein a thickness of the lower part is not less than 50% nor more than 90% of a total thickness of the surface part and the lower part.

2. The electrode according to claim 1, wherein the thickness of the lower part is not less than 40 μm nor more than 160 μm.

3. The electrode according to claim 1, wherein in the lower part, where a particle size of a peak in the particle size distribution of the active material particles is defined as 1, a particle size of another peak is not less than 0.125 nor more than 0.5.

4. The electrode according to claim 2, wherein in the lower part, where a particle size of a peak in the particle size distribution of the active material particles is defined as 1, a particle size of another peak is not less than 0.125 nor more than 0.5.

5. The electrode according to claim 1, wherein the active material particles are carbon particles.

6. The electrode according to claim 2, wherein the active material particles are carbon particles.

7. The electrode according to claim 3, wherein the active material particles are carbon particles.

8. The electrode according to claim 4, wherein the active material particles are carbon particles.

9. An electrochemical device comprising the electrode as set forth in claim 1.
